(19) United States
(12) Patent Application Publication
(10) Pub. No.: US 2018/0106233 A1
(43) Pub. Date: Apr. 19, 2018

(54) FLOATING POWERHOUSE

(71) Applicant: Natel Energy, Inc., Alameda, CA (US)

(72) Inventor: Abraham D. Schneider, San Francisco, CA (US)

(21) Appl. No.: 15/727,229

(22) Filed: Oct. 6, 2017

Related U.S. Application Data
(60) Provisional application No. 62/405,749, filed on Oct. 7, 2016.

(51) Int. Cl. F03B 1/02; F03B 1/04; F03B 3/04; F03B 11/00; F03B 11/02; F03B 11/06; F03B 13/10; F03B 7/00

(52) U.S. Cl. CPC F03B 1/02; F03B 1/04; F03B 3/04; F03B 11/004; F05B 2220/32; F03B 11/06; F03B 13/10; F03B 7/006; F05B 2260/72; F03B 11/02

(57) ABSTRACT

Systems and methods related to floating powerhouse for hydropower turbine systems are presented. A turbine system may be coupled to floating powerhouse that can include a floating platform. A pressurized water delivery system can be coupled to the floating powerhouse and can accommodate vertical and/or horizontal movement of the floating power house. The pressurized water delivery system can include a segmented penstock coupling the turbine to an intake, and individual segments of the penstock can be free to rotate about a substantially horizontal axis, such that in response to variations in a tailwater height, the floating platform rising and falling does not disrupt fluid flow from a fluid source.

### CROSS-REFERENCE TO RELATED APPLICATIONS

This application claims the benefit of U.S. Provisional Patent Application No. 62/405,749, filed Oct. 7, 2016 which is incorporated herein by reference in its entirety, for all purposes. Further, co-owned and co-pending U.S. patent application Ser. Nos. 15/659,457, filed Jul. 25, 2017 (“the '457 application”); and 15/149,984, filed May 9, 2016 (“the '984 application) are also incorporated herein by reference in their entireties, for all purposes. In addition, U.S. Pat. No. 7,645,115, filed Apr. 2, 2007 (“the '115 patent”) is incorporated herein by reference in its entirety.

### BACKGROUND

Hydroelectric power generation harnesses flowing water—typically using a dam or other type of diversion structure—and converts kinetic energy (typically via a turbine) to generate electricity. The power output of a turbine involves the product of vertical head H (the vertical change in elevation the water level) and flow rate Q (the volume of water passing a point in a given amount of time) at a particular site. Head produces water pressure, and the greater the head, the greater the pressure to drive turbines. More head or higher flow rate translates to more power.

As illustrated in FIG. 11, these factors largely determine the type of turbine to be used at a particular site. Other non-limiting factors include how deep the turbine must be installed at a project relative to the water level downstream of the turbine (tailwater), efficiency, and cost.

Although hydraulic turbomachinery has seen widespread use for over a century, most conventional equipment is optimally suited for high head application, where environmental impacts may be severe. Most of the remaining hydroelectric energy generating potential that can be developed with relatively low environmental impact is located at sites with less than 10 meters of head.

Turbines historically finding application at low head have included waterwheels, Archimedean screws, and variations of propeller type turbines. Waterwheels and Archimedean screw turbines are progressive cavity devices, in which a bucket delivers a quantity of water from an upper elevation to a lower elevation, and the water quanta moves at the same speed as the bucket. Consequentially, these types of devices operate slowly and must be very large in order to pass large quantities of water. Propeller turbines and their derivatives, such as Kaplan turbines, can pass large quantities of water moving at high velocity across the turbine blades, but they may require large draft tubes to recover kinetic energy remaining in the fluid after leaving the turbine blades, and the units may need to be installed at a relatively low elevation with respect to the water level downstream of the turbine, to prevent operating problems such as cavitation. Consequentially, conventional turbines designed to produce power from low heads have typically been highly expensive, with extensive civil works necessitated by the operation requirements of the turbines.

As detailed in the '439 application, linear Pelton turbines and linear Pelton turbine systems have several advantages over other conventional hydropower systems and solve many of these issues. Additionally, their novel characteristics further reduce civil works requirements and costs.

For instance, linear Pelton turbine enclosures may be located above the tailwater, minimizing civil work requirements typically required. In contrast, especially in areas at risk of large floods, conventional powerhouse designs can have greater requirements, adding cost to the project. In conventional hydropower systems, the civil works include massive anchors or large quantities of concrete to out-weigh any buoyancy load provided by high water events. This prevents the powerhouse from floating away. Additionally, typical low-head turbines can require deep excavation for draft tubes and turbine setting to avoid cavitation.

### BRIEF SUMMARY

Systems and methods related to floating platforms for hydroelectric power generation systems are presented.

Some embodiments relate to a turbine system, including a turbine, a floating platform supporting the turbine at a tailwater level, and a penstock coupling a fluid flow source to the turbine. The penstock coupling may be flexible to permit vertical movement of the floating platform when the tailwater level changes. In some embodiments, the penstock includes a first penstock pipe section, a second penstock pipe section, and a flexible coupling having a first mating portion connected to the first penstock pipe section and a second mating portion connected to the second penstock mating portion.

In some embodiments, the flexible coupling includes a flexible portion configured to allow the first penstock pipe section and the second penstock pipe section to be disposed at a non-zero angle to one another. In some embodiments, the flexible coupling allows between about 1 degree and about 10 degrees of rotational movement between the first penstock pipe section and the second penstock pipe section. In some embodiments, the flexible coupling allows about 1 degree of rotational movement between the first penstock pipe section and the second penstock pipe section. In some embodiments, the flexible coupling allows about 3 degrees of rotational movement between the first penstock pipe section and the second penstock pipe section. In some embodiments, the flexible coupling allows about 10 degrees of rotational movement between the first penstock pipe section and the second penstock pipe section. The floating platform may be a barge.

In some embodiments, the floating platform includes a draft chamber formed in the floating platform. The floating platform may be substantially constrained along a vertical axis. In response to a severe flood event, the floating platform may be released from the constraint of the vertical axis. A second floating platform may be provided, supporting the turbine.

Some embodiments relate to a turbine system, including a turbine disposed on a barge, and a segmented penstock coupling the turbine to an intake. In some embodiments, individual segments of the penstock can rotate about a substantially horizontal axis in response to a vertical position change of the barge, such that a fluidic connection between the turbine and the fluid flow source is maintained.

In some embodiments, in response to a severe flood event, the floating platform is released from a piling. In some embodiments, the flexible coupling allows between about 1 degree and about 10 degrees of rotational movement between a first penstock segment and a second penstock segment. In some embodiments, the flexible coupling allows about 10 degrees of rotational movement between the first penstock pipe section and the second penstock pipe section. In some embodiments, the flexible coupling allows about 3 degrees of rotational movement between the first penstock pipe section and the second penstock pipe section. In some embodiments, the flexible coupling allows about 1 degree of rotational movement between the first penstock pipe section and the second penstock pipe section.

Some embodiments relate to a turbine system including a turbine supportable by a floating platform, a free jet nozzle to supply a fluid jet to the turbine and a housing. In some embodiments, the housing may be configured to isolate the turbine and nozzle from an external atmosphere, and include a chamber enclosing the turbine and nozzle, the chamber having an outlet formed in a surface of the floating platform that is hydraulically sealed to an outlet fluid body, after the fluid jet contacts the turbine, fluid leaving the turbine exits the housing through the outlet. In some embodiments, the system includes a control valve configured to control an amount of air in the chamber to maintain a desired elevation of suction head inside the chamber without allowing the outlet fluid body to contact the turbine.

In some embodiments, the system includes a segmented penstock coupling the turbine to an intake, and individual segments of the penstock are free to rotate about a substantially horizontal axis, such that in response to variations in a tailwater height, the floating platform rising and falling does not disrupt fluid flow from a fluid source. In some embodiments, the system includes a drive shaft driven by the turbine, the drive shaft extending through the housing and configured to drive an electric generator positioned exterior to the housing. In some embodiments, air from the enclosed atmosphere is entrained in the form of bubbles and momentum of the outflow evacuates the entrained bubbles of the enclosed atmosphere from the chamber. In some embodiments, the control valve is configured to automatically maintain a level of a fluid pool below the turbine. In some embodiments, the control valve is configured to automatically maintain a pressure inside the chamber below the external atmospheric pressure so as to increase a level of a fluid pool below the turbine.

In some embodiments, related methods are envisioned, such as a method for operating a hydraulic turbine on a floating platform. In some embodiments, the method may include operating a turbine system disposed on a floating platform in a first configuration at a first tailwater level, and operating the turbine system disposed on a floating platform in a second configuration at a second tailwater level different from the first tailwater level such that a flexible penstock allows for the floating platform to rise and fall with changing tailwater level.

In some embodiments, related methods of constructing a turbine system, floating platform such as a barge, and a flexible penstock such as a segmented penstock are envisioned. For example, in some embodiments, a method of manufacturing may include transporting constituent components of one or more of the turbine system, floating platform such as the barge, and the flexible penstock to an installation site as modular components. In some embodiments, the floating platform may be coupled to the turbine system, and floated into place at the installation site.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the pertinent art to make and use the invention.

FIG. 1A is a perspective view of a floating powerhouse system in a first configuration according to an embodiment.

FIG. 1B is a perspective view of a floating powerhouse system in a second configuration according to an embodiment.

FIG. 2 is a perspective view of a flexible coupling of a flexible penstock according to an embodiment.

FIG. 3A is a perspective view of a floating powerhouse system according to an embodiment.

FIG. 3B is a perspective view of a floating powerhouse system according to an embodiment.

FIG. 4 is a plan view of an array of floating powerhouse systems according to an embodiment.

FIG. 5A is a perspective view of a floating powerhouse system array according to an embodiment.

FIG. 5B is a perspective view of a floating powerhouse system array according to an embodiment.

FIG. 6 is a plan view of a floating powerhouse system array according to an embodiment.

FIG. 7A is a plan view of a floating powerhouse system according to an embodiment.

FIG. 7B is a sectional view of the floating powerhouse system of FIG. 7A taken along line A-A.

FIG. 8 is a perspective view of a floating powerhouse system according to an embodiment.

FIG. 9 is a perspective view of a floating powerhouse system of FIG. 8.

FIG. 10A is a plan view of a floating powerhouse system according to an embodiment.

FIG. 10B is a sectional view of the floating powerhouse system of FIG. 10A taken along line A-A.

FIG. 10C is a sectional view of the floating powerhouse system of FIG. 10A taken along line A-A.

FIG. 11 depicts application ranges for various type of hydraulic turbomachines, a plot of as Q vs. H with lines of constant power determined assuming η₀=0.8.

FIG. 12 is a plot of efficiency vs. Q/Q₀ for various types of turbines.

FIG. 13 is a schematic side view of a conventional Pelton turbine.

FIG. 14 is a schematic sectional view of a conventional Pelton turbine with velocity vectors.

### DETAILED DESCRIPTION OF THE INVENTION

By way of background, turbines convert the kinetic energy of a moving fluid to useful shaft work by the interaction of the fluid with a series of buckets, paddles, or blades arrayed about the circumference of a runner. Two main classes of turbines (impulse and reaction) have many variations. Reaction machines utilize a pressure drop across the moving blades. A reaction turbine develops power from the combined action of pressure and moving water. Reaction turbines are generally used for sites with lower head and higher flows than compared with the impulse turbines. In an impulse machine, the entire pressure drop occurs before the fluid interacts with the moving blade, so pressure is constant across the moving blades. Conventional impulse turbines include a runner designed to rotate about a single axis when the force of a stream of water hits blades or buckets that are mounted around the perimeter of a runner. Typically, there is no suction on the outlet (e.g., down) side of the turbine, and the water falls out the bottom of the turbine housing after leaving the buckets. Conventional impulse turbines are generally suitable for high head, low flow applications.

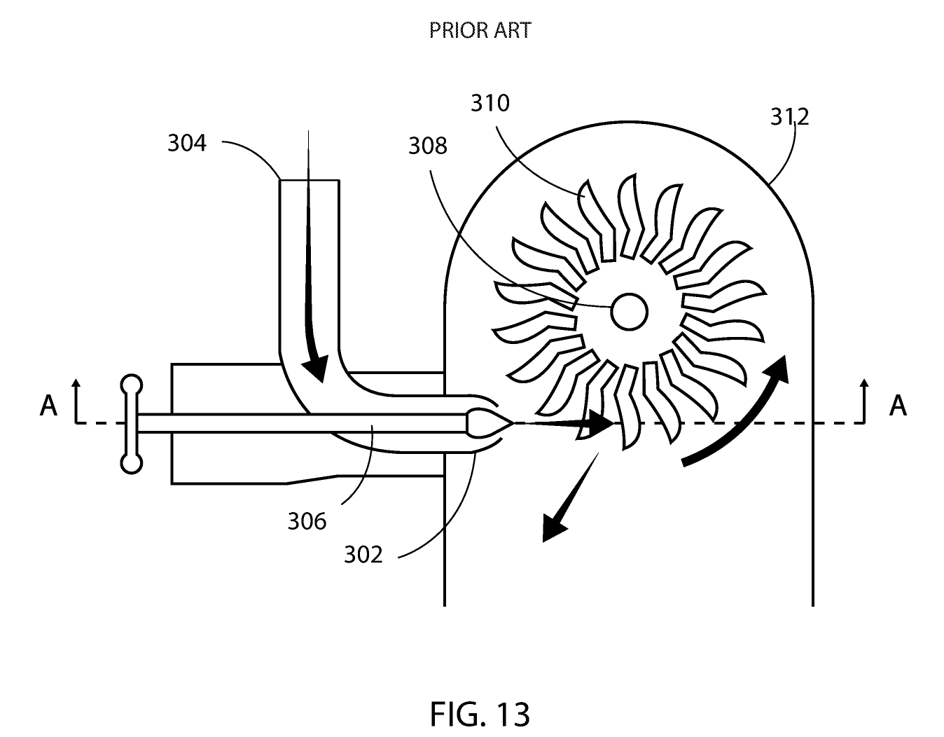

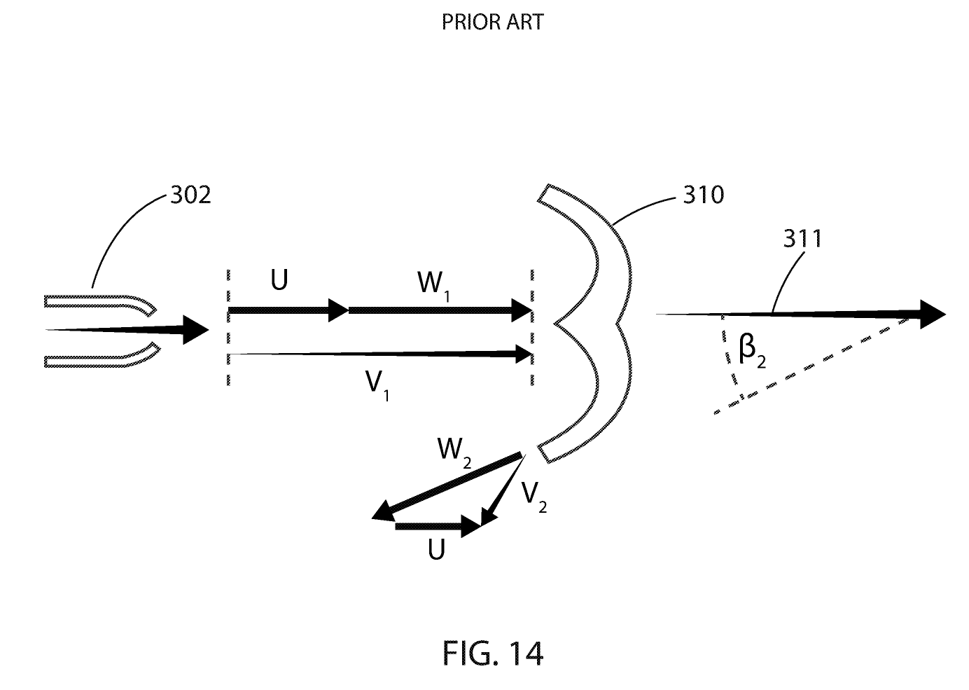

The Pelton turbine is the most common type of hydraulic impulse turbine in use today. FIGS. 13 and 14 depict a conventional Pelton turbine arrangement in a case 312. The Pelton turbine has one or more nozzles 302 that are positioned to orient a jet of water 303 tangential to a rotatable wheel. A plurality of Pelton buckets 310 are mounted about the perimeter of the rotatable wheel. Jet 303 impacts the plurality of Pelton buckets 310 on the wheel at their centers. The impact on the plurality of Pelton buckets 310 results in a torque, causing the wheel to rotate a coaxial drive shaft 308. The drive shaft 308 may in turn drive a generator to produce electricity. Flow rate through the nozzle is adjustable through use of a valve, such as a spear valve. An adjustable spear 306 has a tapered point which cooperates with the nozzle 304 to act as a control valve to adjust the flow of the water jet.

The curvature of the Pelton buckets is chosen so that the exiting flow is turned to a direction nearly opposite to that of the incoming jet. A practical limit of this turning angle is about 165° in order to avoid subsequent buckets splashing against the outflow. Even with this limitation, Pelton turbines today typically have peak efficiency of about 0.9 (about 90%), with multi-jet Pelton wheels (multiple individual jets arranged around the wheel to simultaneously push different buckets on the wheel) having efficiency exceeding 0.92. However, these turbines have the smallest specific speed of any common turbine, and thus are limited in use to very high head, e.g., over 90 meters, and frequently over 1,000 meters. Turgo turbines behave in a manner similar to Pelton turbines, but allow increased specific speed by allowing flow to intersect multiple sequential blades at once. However, Turgo turbines are still medium-to-high-head machines, with most units being utilized above 50 meters of head.

The turbine is may be installed such that the lowest moving components (as installed at an installation site) are located above the tailwater. The turbine may be equipped to operate within a case, chamber or housing capable of maintaining a vacuum relative to the ambient atmosphere, enabling the turbine to avoid loss of head below the turbine by locally elevating the tailwater inside the case. This may be true even in embodiments utilizing a floating platform, and results in the tailwater inside the case being at a level higher than the ambient surrounding tailwater. In an embodiment utilizing the floating powerhouse system described herein, the tailwater level inside the case may also vary as the powerhouse rises and falls with the tailwater outside of the case. These and other features allow the turbine to be installed above tailwater in a way that substantially reduces civil works costs.

Embodiments of a system, method, and apparatus for producing power from a fluid source (e.g., fluid impulse source) address a significant challenge in the capture of low-head fluid power resources, such as low-head hydropower. Embodiments may be configured for use at drops in elevation in natural waterways (e.g., river) or constructed waterways (e.g., a canal).

Embodiments of the floating powerhouse described herein cooperate with a pressurized fluid source, for example, a penstock. The primary purpose of a penstock or tunnel is to transport water from a fluid intake and deliver it to the hydraulic turbine in the powerhouse. Once the water has been delivered to the turbine, it is then released downstream into a discharge channel. Specifically, penstocks are pressurized conduits that transport pressurized water from a first free water surface to a turbine. Penstocks can be either exposed or built integral with a dam structure. Characteristics of functional penstocks are structural stability, minimal water leakage, and maximum hydraulic performance. A typical penstock can be constructed of large round steel cross-sections and can be fabricated welded steel, pre-stressed or reinforced concrete, glass-reinforced plastic (GRP), and PVC plastic pipes.

Embodiments of the floating powerhouse disclosed herein can support a number of potential turbine types, including both impulse and reaction type machines of both single-axis (rotational) and linear form factor. In one aspect, the turbine can be the turbine described in the '457 application. In another aspect, the turbine can be the turbine described in the '984 application. In another aspect, the turbine can be the turbine described in the '115 patent. In an aspect, the turbine can be a free jet impulse turbine. A free jet impulse turbine can be linear or rotating (single-axis) Pelton turbines, linear crossflow turbines, conventional rotary crossflow turbines, Turgo turbines, and turbines of the Fourneyron and Girard type. Each of these turbines utilizes a nozzle or multiple nozzles to direct a free jet of high velocity water at moving blades, which subsequently turn the water as steeply as possible, extracting useful work by decelerating the water. Hydroelectric free jet impulse turbines use a runner surrounded by air, that receives the high velocity fluid flow. These kinds of turbines cannot efficiently operate with the runner in contact with tailwater. For efficient operation the runner must operate surrounded by air and cannot utilize the energy represented by water free-fall below the runner. In a typical powerhouse, the water and energy in free-fall below the runner can represent a major and prohibitively large loss. For example, typical rivers can experience tailwater fluctuations of two meters or more, which represents 25% of the available head of an eight meter drop. It is possible to equip a free jet impulse turbine with a draft chamber, utilizing bubble evacuation to raise the water level inside the draft chamber locally, and recover some of the free-fall head. But utilization of a draft chamber can require additional cost and complexity due to the required equipment covers, sealed joints, shaft seals, and vents, and the draft chamber can cause additional losses at its outlet. In contrast, the floating powerhouse system disclosed herein allows the turbine to passively maintain close proximity to tailwater regardless of tailwater elevation fluctuations and does not require the turbine to operate in a sealed atmosphere. This is beneficial because it maintains the efficiency of the turbine over varying tailwater levels with fewer required civil works structures and lower investment.

In another aspect, the turbine can be a reaction turbine. For example, the floating powerhouse system can be utilized with reaction turbines, such as Propellor turbines, Kaplan turbines, bulb turbines, tube turbines, and Francis turbines. Typically, reaction turbines require a submarine powerhouse. The floating powerhouse system is beneficial for use with these reaction turbines because it can allow such turbines to be installed without the high cost of a conventional submarine powerhouse. In these types of turbines, the runner operates in a fully water-filled and pressurized casing. Especially at low heads, the runner specific speed is high, and thus axial flow rates through the turbine are high, and the turbines require an outlet diffuser for efficient operation. Reaction turbines experience very low static pressure in the water near the runner, and a primary concern with these types of turbines is the choice of elevation of the runner so that cavitation is prevented. Cavitation is the formation of vapor bubbles in the liquid flowing through the turbine. Cavitation can cause damage to the turbine including pitting of the metallic surfaces of turbine parts and/or other damage. The floating powerhouse system can allow the turbine to maintain a constant desired elevation with respect to tailwater, compatible with cavitation and other operational constraints, regardless of fluctuations in the lower water level.

A typical approach to the design of the powerhouse for low head hydropower plants, particularly in natural river settings subject to occasional flooding or high water events, involves an assessment of anticipated equipment layout leading to an estimate of total floorplan area. This total floorplan area is subsequently utilized to estimate a buoyancy load for the powerhouse in the event of high water. In other words, a hydropower plant must be designed to prevent the powerhouse from floating away during a high water event. To offset the powerhouse buoyancy load, typical civil engineering design requires sufficient mass of material such as concrete and steel, as well as anchoring methods to maintain the powerhouse on its foundation during a high water event. Additionally, conventional low-head reaction turbines such as Kaplan, bulb, or even Francis turbines, require adequate submergence in order to prevent cavitation. This requirement in addition to the size and form of turbine components such as draft tubes, lead to deeply excavated civil structures, construction of which must often be protected with temporary and costly coffer dams.

The configuration of the floating powerhouse described herein does not require burdening the powerhouse with massive quantities of concrete to overcome buoyancy. Instead, the powerhouse buoyancy is specifically incorporated into the system design. Embodiments of the present system enable lightweight, inexpensive powerhouses to be built to float on top of the tailwater. In this way, the powerhouses, which may include the turbine itself, rise and fall with natural or controlled changes in flow rate and tailwater height.

Simple fabrication of a floating platform may be utilized. The floating platform can be a modular barge. As used herein, “pilings” refer to temporary pilings, also known as “spuds,” and/or permanent pilings. The pilings are driven into place, e.g., in the riverbed, and restrain horizontal motion of the floating powerhouse but allow vertical motion as the water rises and falls. As explained herein, the turbine may be configured such that it sits on top of the barge modular platform, or may be configured to take advantage of barge openings to allow for easy introduction of water flow into the turbine. Other structures are contemplated for buoyancy addition, such as custom buoyant chambers rather than modular barges. Buoyant chambers may be attached to various parts of the system, such as the penstock, to provide support and eliminate moment-loading on the system.

Additionally, during extreme flood events, the entire powerhouse may be disconnected from the penstock. Further, the entire powerhouse may be disconnected from the pilings, allowing the movement of the powerhouse out of the area affected.

Advantageously, this simplifies powerhouse infrastructure production off-site. For example, wiring, air, hydraulic lines, etc., may be pre-fabricated and assembled off-site, with limited on-site finishing. Routing to carry power and data to and from the floating powerhouses, can be configured according to best practices in the industry. For example, electricity and control wires can be routed along the penstock, connecting the floating powerhouse to shore.

A unique pressurized water-delivery system is required, such that it has the ability to move up and down along with the floating powerhouse. As described herein, in an embodiment flexible couplings can be used to create a segmented penstock coupled to an intake. In the regard, multiple short sections of penstock pipe may be coupled together to create a flexible segmented penstock able to provide a large range of vertical motion (e.g., several meters) with relatively small deflections at each joint. In another aspect, the penstock can incorporate one or more flexible joints, such as a gimbal joint that utilizes a bellows system. In another aspect, the entire penstock may be made from a flexible material. In another aspect, the flexible joints can take the form of swivels which may freely rotate about the local pipe axis. In a further aspect, the penstock can be attached to a movable gate that slides up and down in a dam based on the water level. In another aspect, the pressurized water-delivery system can incorporate one or more of the above mentioned design features.

As discussed below in detail, embodiments of the pressurized water-delivery system allow the entire floating platform to rise and fall with the tailwater, without interruption of fluid flow to the turbine system.

Although specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

As used herein, ranges are inclusive of endpoints.

As used herein, “substantially,” and “about,” when used in combination with ranges, are used to include variation of around +/−5% of the recited value.

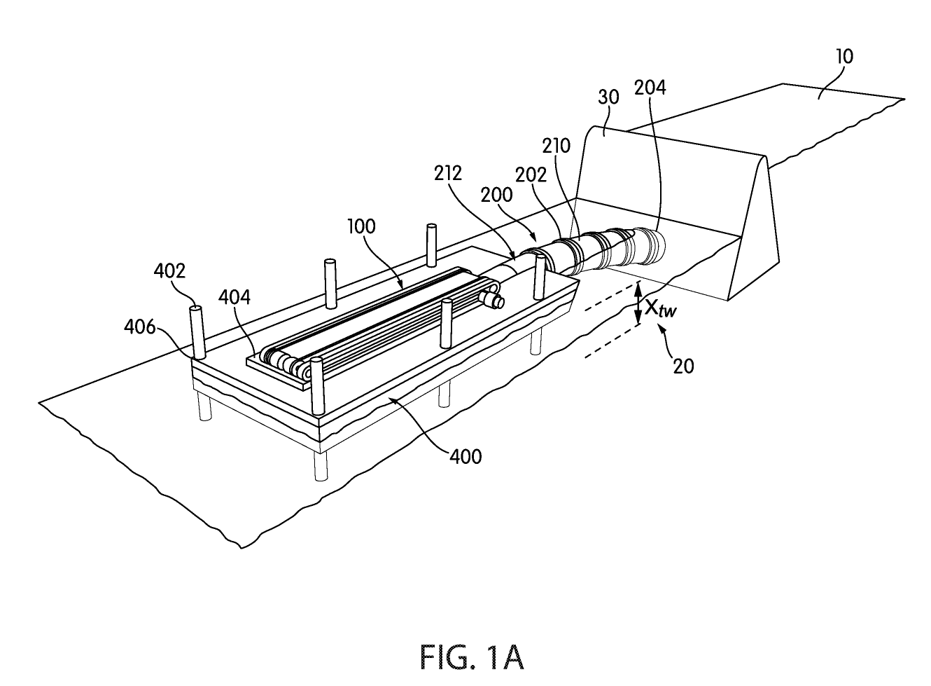

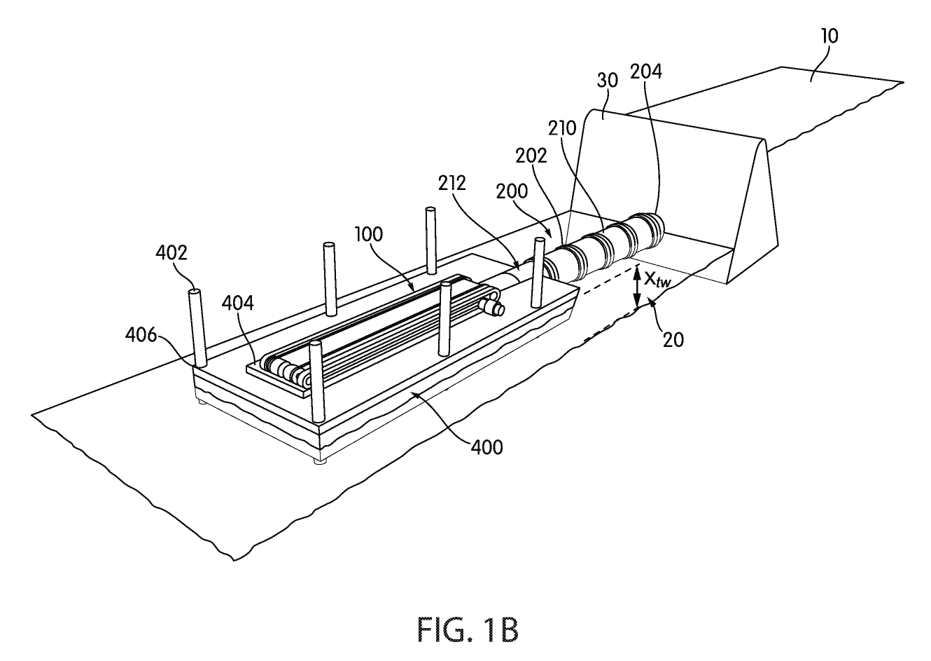

Turning to FIGS. 1A-B, a turbine system 100 is shown, coupled to floating platform, such as a floating powerhouse 400. As discussed above, turbine system 100 can be any kind of hydroelectric turbine including impulse and reaction type machines of both rotating and linear form factor. Floating powerhouse 400 may be constructed as a simple watertight module, e.g., constructed from steel. Floating powerhouse 400 has bearing guides 406 that allow travel along pilings 402, as shown. Pilings 402 can be configured as permanent or temporary and can be anchored into the installation site, such as the riverbed or seafloor, depending on the installation requirements.

Floating powerhouse 400 may include a standardized modular spud barge, either constructed on-site from modular components, or pre-fabricated and installed with minimal on-site fabrication. In some embodiments, multiple floating powerhouses 400 may be coupled together, e.g., to support a very large turbine system 100 or to support multiple linear turbine systems 100. As shown, floating powerhouse 400 may have an opening 404, which may allow for water leaving turbine system 100 to directly exit through floating platform 400. Turbine system 100 may be supported by a support structure at one or more points along opening 404. In some embodiments, opening 404 is not required. In some embodiments, opening 404 may be configured as a draft chamber, described below.

As shown in FIG. 1A, the system is installed at the site of a dam 30, e.g., a previously non-powered dam. Dam 30 provides for an upper pool 10, upstream of turbine system 100, which feeds water flow to turbine system 100 for power conversion purposes. Downstream of dam 30, tailwater 20 is shown, with reference distance Xtw defining a general tailwater level/height as the distance between the tailwater surface and a predetermined distance from the riverbottom or other surface which the pilings 402 are driven into. As described above, natural variation in tailwater height is to be expected, especially in areas prone to flooding, or large changes in flow rate. A lower level of tailwater is shown in FIG. 1B, showing floating powerhouse 400 lower on the pilings 402, which are allowed to slide through bearings or guide bushings 406, and segmented penstock 200 straightened out, e.g., at a different angle relative to horizontal. Prior systems did not adequately provide for a floating powerhouse such as the one shown in FIGS. 1A and 1B, in part because of their large size, and heavy civil works requirements. Additionally, prior systems did not adequately provide for a floating powerhouse such as the one shown in FIGS. 1A and 1B, in part due to the conventional design approach for submersible stationary hydropower plants.

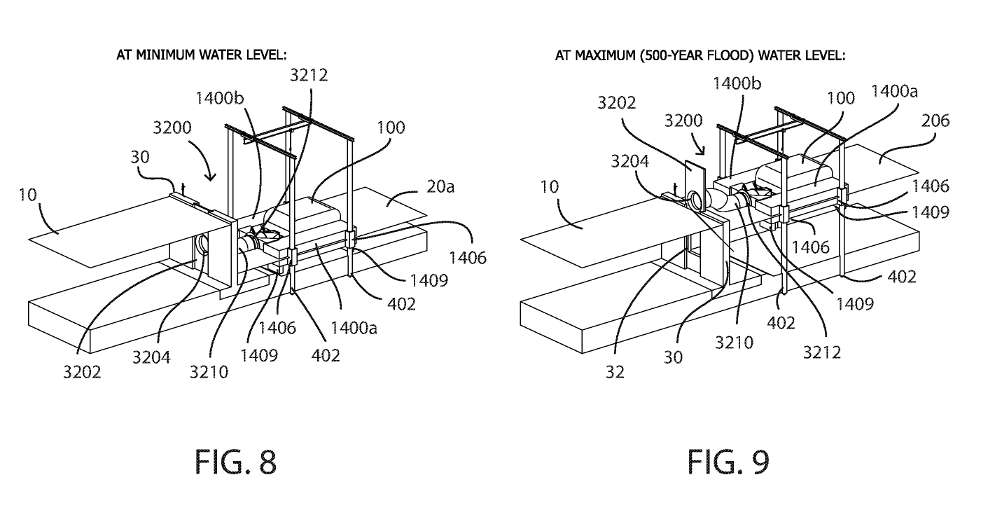

As shown in the figures, floating powerhouse 400 can include bearings 406, through which pilings 402 retain and position floating powerhouse 400. In some embodiments, bearings 406 may allow translation about pilings 402, such that floating powerhouse 400 may move, e.g., rotate in a plane parallel to the tailwater level. In some embodiments, the height of pilings 402 may be selected based on a predetermined tailwater level, such that they are high enough to ensure spud barge 400 is not released unnecessarily during normal fluctuations in tailwater level. In some embodiments, the pilings 402 and or floating powerhouse 400 may additionally include a drought protection mechanism (such as drought protection mechanism 1409, shown in FIGS. 8-9, 10A-10C), e.g., a feature or mechanism such as a bumper or leg designed to safely place floating powerhouse 400 with turbine system 100 on the floor of the riverbed. In this way, floating powerhouse 400 and penstock 200 may be protected (e.g., excessive deformation of penstock 200, etc.) by limiting how low powerhouse 400 can fall.

FIGS. 1A and 1B also show a pressurized water source, e.g., segmented flexible penstock 200 that can connect to turbine system 100 at a first end 212 to supply water flow to the system 100. A second end of segmented penstock 200 may define an intake 204, receiving water flow from dam 30. As shown, separate segments of penstock pipe 210 may be coupled together by flexible couplings 202. In this way, the system is configured to accommodate large and frequent changes in vertical position of the turbine inlet. In some embodiments, penstock pipe 210 may be rigid, as opposed to flexible coupling 202. In some embodiments, segmented penstock 200 may be constructed from multiple flexible couplings 202 connected together, without any rigid penstock pipe 210. In some embodiments, penstock pipes 210 may be coupled to each other, through penstock coupling 202, in multiple sections, e.g., about 3, 5, 10 sections, etc. In some embodiments, segmented penstock 200 may be constructed from a single flexible section.

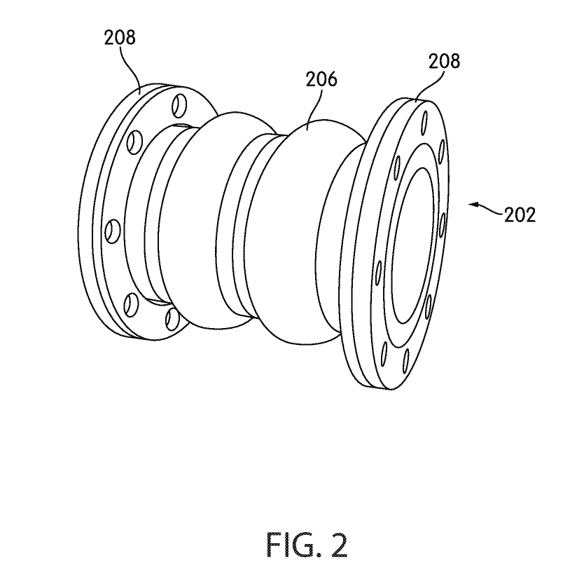

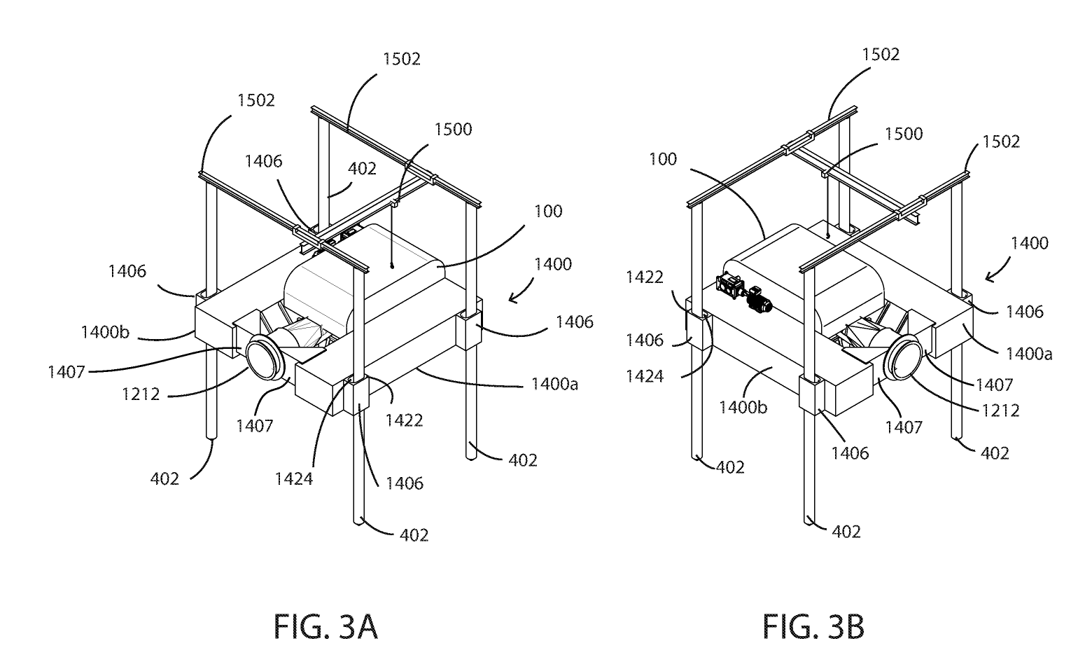

Turning to FIG. 2, flexible coupling 202 is shown. Flexible coupling 202 may include mating portions 208, which may bolt to a section of penstock pipe, or to another flexible coupling 202. Flexible coupling 202 may also include flexible portion 206. As configured, the flexible coupling 202 serves as a flexible joint (e.g., double-convolution form). Flexible coupling 202 may also be flexible along its axis, such that it may extend or compress with changes in relative positioning between components it is connected to. In this regard, between about 1 degree and about 10 degrees of rotational movement per joint may be provided for a 120 inch diameter pipe, for example. As a non-limiting example, a penstock built from five, 3 meter long pipe sections separated by flexible coupling 202 may allow approximately 3.7 meters of vertical motion at the spud barge 400. Other ranges are envisioned, driven in part by the length and diameter of penstock pipe sections, number of sections, flexibility of couplings, site geometry and characteristics, etc. In some embodiments, measurements may be taken such that the generally required travel of the floating platform is known prior to construction and installation. In some embodiments, the segmented penstock 200 may allow for horizontal movement as well, such that spud barge 400 is not constrained to solely vertical movement. In some embodiments, the system may include a thrust bracket (such as thrust bracket 1407, shown in FIGS. 3A and 3b), which is configured to takes the main loads from penstock 200. Advantageously, thrust bracket 1407 may be configured to take the loads resulting from the natural sweep of penstock 200 (when the lower water level fluctuates), rather than subjecting turbine 100 to those loads. Instead, loads are transferred into floating platform 400 (e.g., barge). Alternatively, the floating platform may be constrained to move only vertically; in this case the penstock may be configured with sufficient flexure or mechanisms to allow such vertical movement without any horizontal movement of the platform nor turbine, or alternatively the turbine 100 may be mounted on rails, and may absorb natural sweep of penstock 200 when the lower water level fluctuates.

In some embodiments, some or all of the entire system including the turbine system 100 and its component parts, the penstock, the floating platform and associated components may be manufactured completely off-site, and transported to the ultimate installation site. In some embodiments, the components may be transported as components, fully assembled, or assembled into subassemblies for ultimate finishing at the installation site. In an aspect, the system components can be floated along the waterway to the project location. In this respect, the remaining site specific work includes installation of pilings 402 and construction of intake 204 mating to dam 30. In some embodiments, segmented penstock 200 may include a siphon portion, allowing for less intrusive construction—e.g., no heavy intake need by cut into dam 30.

In some embodiments, one or more of flexible couplings 202 or pilings 402 may be decoupled from the floating powerhouse 400 in response to a severe flood event. Flexible couplings 202 may simply disconnect from first end 212, such that floating powerhouse 400 is free to move away from the site, once pilings 402 are decoupled from floating powerhouse 400. In other embodiments, penstock 200 may decouple from intake 204, and remain attached at first end 212.

In some embodiments, related methods are envisioned, such as a method for operating a hydraulic turbine on a floating platform. In some embodiments, the method may include operating a turbine system disposed on a floating platform in a first configuration at a first tailwater level, and operating the turbine system disposed on a floating platform in a second configuration at a second tailwater level different from the first tailwater level such that a pressurized water delivery system allows for the floating platform to rise and fall with changing tailwater level.

In some embodiments, related methods of constructing turbine system 100, floating platform such as floating powerhouse 400, and pressurized water delivery system such as segmented flexible penstock 200 are envisioned. For example, in some embodiments, a method of manufacturing may include transporting constituent components of one or more of the turbine system 100, floating platform such as floating powerhouse 400, and pressurized water delivery system such as segmented penstock 200 as modular components to be assembled at an installation site. In some embodiments, floating powerhouse 400 may be coupled to turbine system 100, and floated into place at the installation site.

In some embodiments, a floating platform, such as floating powerhouse 400, customized for supporting a turbine or like system is envisioned, having the features described herein. In some embodiments, turbine system 100 may be separately provided from floating powerhouse 400.

Turning to FIGS. 3A-3B, floating powerhouse 1400 is shown. A turbine system 100 can be coupled to floating platforms 1400a and 1400b, respectively. As discussed above, turbine system 100 can be any kind of hydroelectric turbine including impulse and reaction type machines of both rotating and linear form factor. Floating platforms 1400a and 1400b may be constructed as a simple watertight module, e.g., constructed from steel. Floating powerhouse 1400 has bearing guides 1406 that allow travel along pilings 402 and position and support floating powerhouse 1400, as shown. In some embodiments, bearing guides 1406 may allow translation about pilings 402, such that floating powerhouse 1400 may rotate in a plane parallel to the tailwater level. In some aspects, bearing guides 1406 can include an oval cavity 1422 to allow horizontal movement of the floating powerhouse 1400 about the pilings 402 as the floating powerhouse moves vertically about pilings 402 based on the level of tailwater 20. In an aspect, bearing guides 1406 can include bearings 1424 to reduce friction between bearing guides 1406 and pilings 402. Bearings 1424 can include a replaceable bearing or bushing, such as a polymer or elastomeric bearing, along an interior surface of oval cavity 1422. In another aspect, bearing 1424 can include a lubricant.

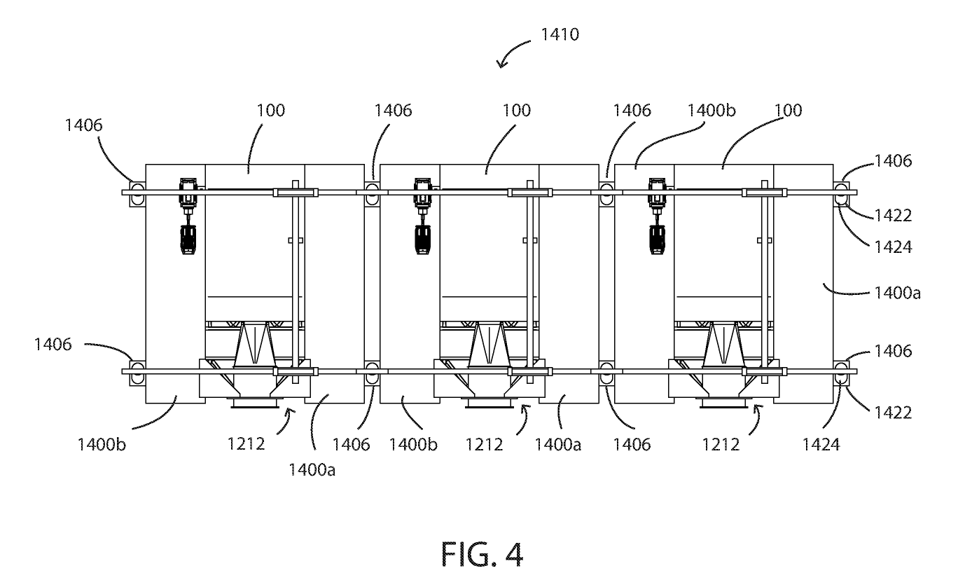

As shown in FIG. 4, two or more floating powerhouses 1400 can be combined in a floating powerhouse array 1410. In this aspect, bearing guides 1406 can connect a floating platform 1400a of a first floating powerhouse 1400 to a floating platform 1400b of a second floating powerhouse 1400. In other aspects of the invention, each floating powerhouse 1400 can be connected to an adjacent floating powerhouse 1400, for example, by a bearing guide 1406. Physically connecting each floating powerhouse 1400 to an adjacent floating powerhouse 1400 to form a floating powerhouse array 1410 can allow loads to be distributed across all pilings 402.

Floating powerhouse 1400 may include a standardized modular barge as either of floating platforms 1400a and/or 1400b, either constructed on-site from modular components, or pre-fabricated and installed with minimal on-site fabrication. In some embodiments, multiple floating platforms 1400a and/or 1400b may be coupled together, e.g., to support a very large turbine system 100. As shown in the figure, floating powerhouse 1400 may have an opening 1404, which may allow for water leaving turbine system 100 to directly exit through floating powerhouse 1400. Turbine system 100 may be supported by a support structure at one or more points along opening 1404. In some embodiments, opening 1404 is not required. In some embodiments, opening 1404 may be configured as a draft chamber, described below.

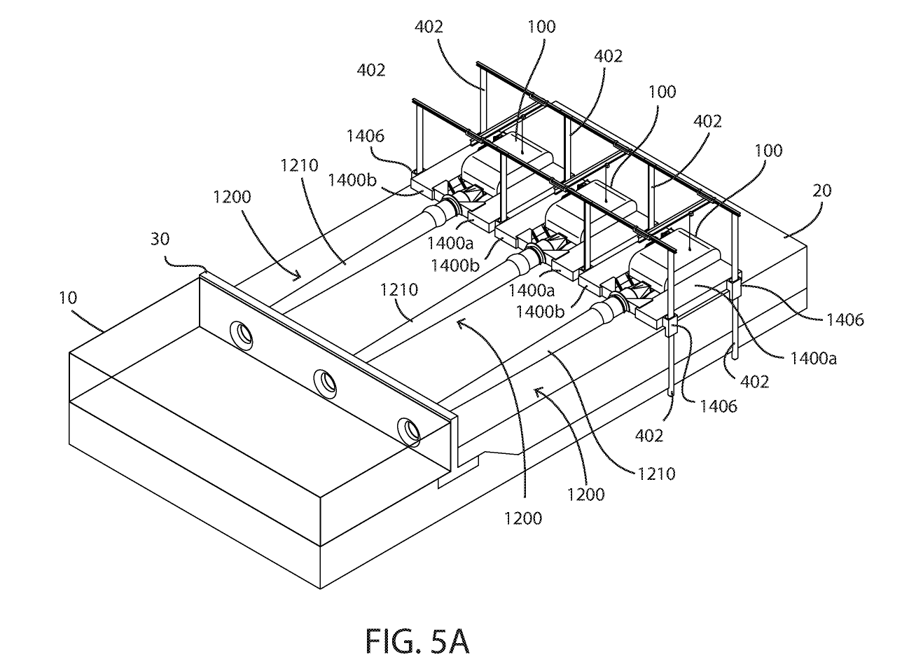

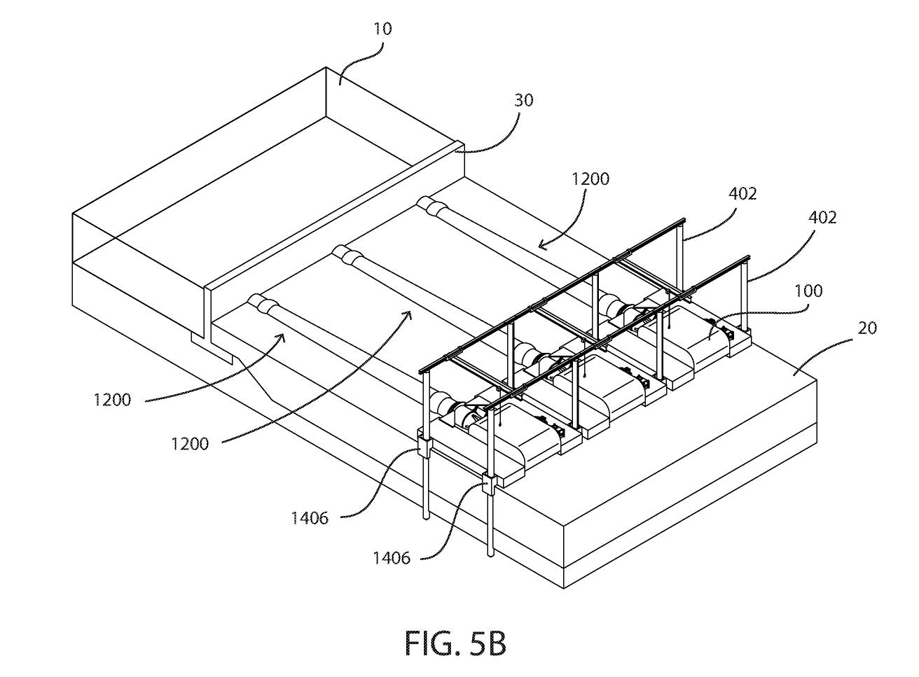

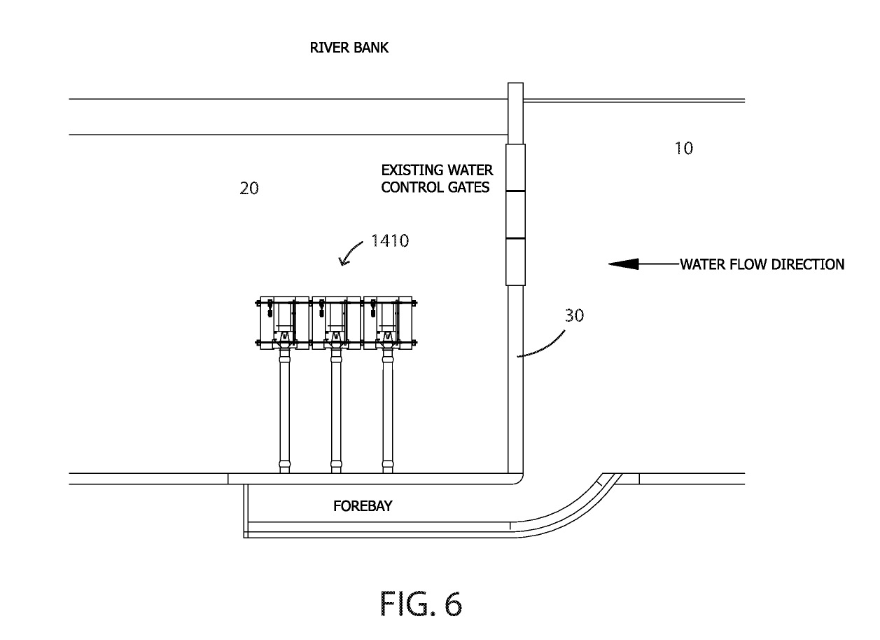

As shown in FIGS. 5A-5B and 6, the system can be installed at the site of a dam 30, e.g., a previously non-powered dam. Dam 30 provides for an upper pool 10, upstream of turbine system 100, which feeds water flow to turbine system 100 for power conversion purposes. Downstream of dam 30, tailwater 20 is shown that is a distance from the riverbottom or other surface which the pilings 402 are driven into. As described above, natural variation in tailwater height is to be expected, especially in areas prone to flooding.

Floating powerhouse 1400 can be coupled to a pressurized water delivery system 1200 that accommodates the vertical movement of the floating powerhouse 1400. In an aspect, the pressurized water delivery system 1200 can be a flexible penstock, e.g., segmented flexible penstock 200 discussed above. In another aspect, the pressurized water delivery system 1200 can be a flexible penstock that includes a flexible penstock pipe 1210. Flexible penstock pipe 1210 can be made from a flexible material that elastically deforms to accommodate the vertical movement of floating powerhouse 1400. In this way, the system is configured to accommodate large and frequent changes in vertical position of the turbine inlet 1212.

In an aspect, a pressurized water delivery system 1200 can connect to turbine system 100 at a turbine inlet 1212 to supply water flow to the system 100. A second end of pressurized water delivery system 1200 may define an intake 1204, receiving water flow from dam 30.

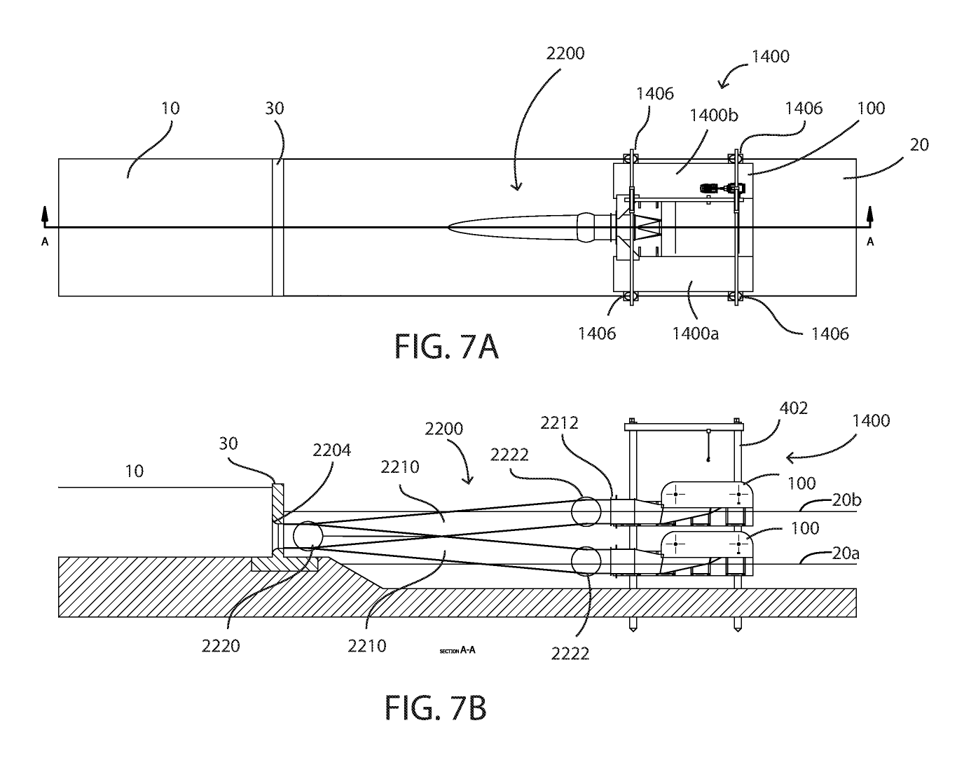

As shown in FIGS. 7A-7B, a pressurized water delivery system 2200 can include a penstock pipe 2210 that can be rigid or can be flexible similar to flexible penstock pipe 1210 or segmented flexible penstock 200. Pressurized water delivery system 2200 can include one or more flexible couplings 2220 and 2222 at one or more ends of penstock pipe 2210. In an aspect, flexible couplings 2220 and/or 2222 can be similar to flexible coupling 202 discussed above. In another aspect, flexible couplings 2220 and/or 2222 can be gimbal joints that include a bellows.

Flexible couplings 2220 and/or 2222 may be flexible along an axis, such that they may extend or compress with changes in relative positioning between components it is connected to. In this regard, between about 1 degrees and about 10 degrees of rotational movement per joint may be provided for a 120 inch diameter pipe, for example. As a non-limiting example, a penstock built from five, 3 meter long pipe sections separated by flexible coupling 202 may allow approximately 3.7 meters of vertical motion at the spud barge 400. Other ranges are envisioned, driven in part by the length and diameter of penstock pipe sections, number of sections, flexibility of couplings, site geometry and characteristics, etc. In some embodiments, measurements may be taken such that the generally required travel of the floating platform is known prior to construction and installation. In some embodiments, the penstock pipe 2210 may allow for horizontal movement as well, such that floating powerhouse 1400 is not constrained to solely vertical movement.

Low tailwater level 20a and high tailwater level 20b are shown in FIG. 7B, showing floating powerhouse 1400 lower on the pilings 402 at low tailwater level 20a and higher on pilings 402 at high tailwater level 20b. Floating powerhouse 1400 slides about pilings 402 via bearing guides 1406, as discussed above. Prior systems did not adequately provide for a floating powerhouse such as the one shown, in part because of their large size, and heavy civil works requirements.

As shown in FIGS. 8-10C, floating powerhouse 1400 can be coupled to a pressurized water delivery system 3200 that accommodates the vertical movement of the floating powerhouse 1400. In an aspect, the pressurized water delivery system 3200 can include a gate 3202 that slides vertically in dam channel 32. In this way, the system is configured to accommodate large and frequent changes in vertical position of the turbine inlet 3212 based on the level of tailwater 20. In an aspect, gate 3202, penstock pipe 3210, floating powerhouse 1400, and turbine 100 can move vertically as a unit to accommodate large and frequent changes of the level of tailwater 20.

In an aspect, a pressurized water delivery system 1200 can connect to turbine system 100 at a turbine inlet 3212 to supply water flow to the system 100. A second end of pressurized water delivery system 3200 may define an intake 3204, receiving water flow from dam 30.

Pressurized water delivery system 3200 can include a penstock pipe 3210 that can be rigid or can be flexible similar to flexible penstock pipe 1210, discussed above. Pressurized water delivery system 3200 can include one or more flexible couplings, similar to flexible couplings 202 and/or 2220 and 2222 discussed above.

As a non-limiting example, pressurized water delivery system 3200 including gate 3202 can allow approximately 3.7 meters of vertical motion of floating powerhouse 1400. Other ranges are envisioned, driven in part by the length and diameter of penstock pipe sections, number of sections, flexibility of couplings, site geometry and characteristics, etc. In some embodiments, measurements may be taken such that the generally required travel of the floating platform is known prior to construction and installation. In some embodiments, the pressurized water delivery system 3200 may allow for horizontal movement as well, such that floating powerhouse 1400 is not constrained to solely vertical movement.

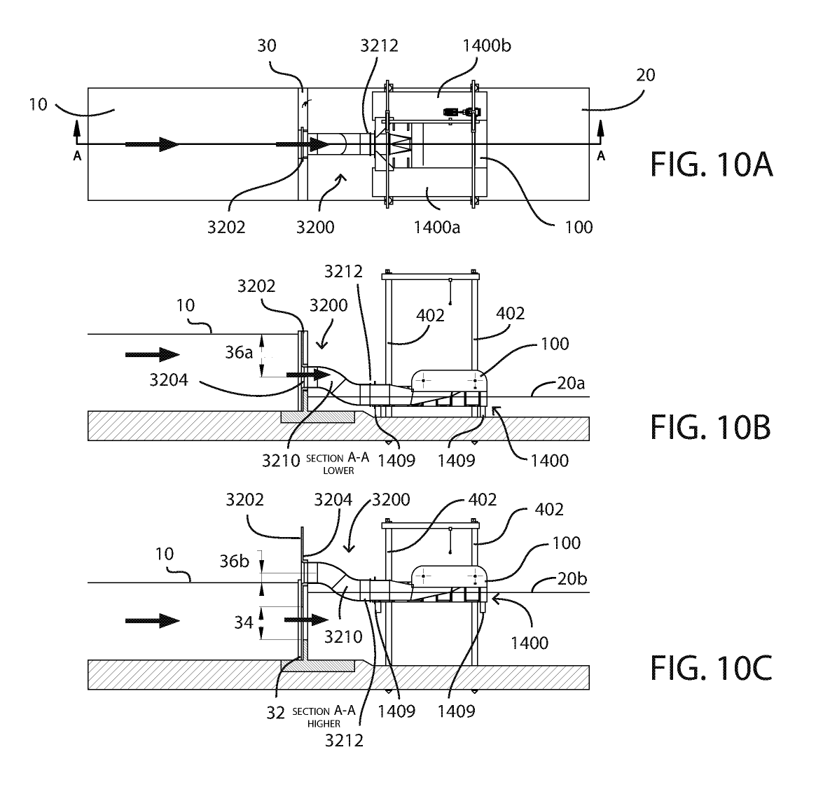

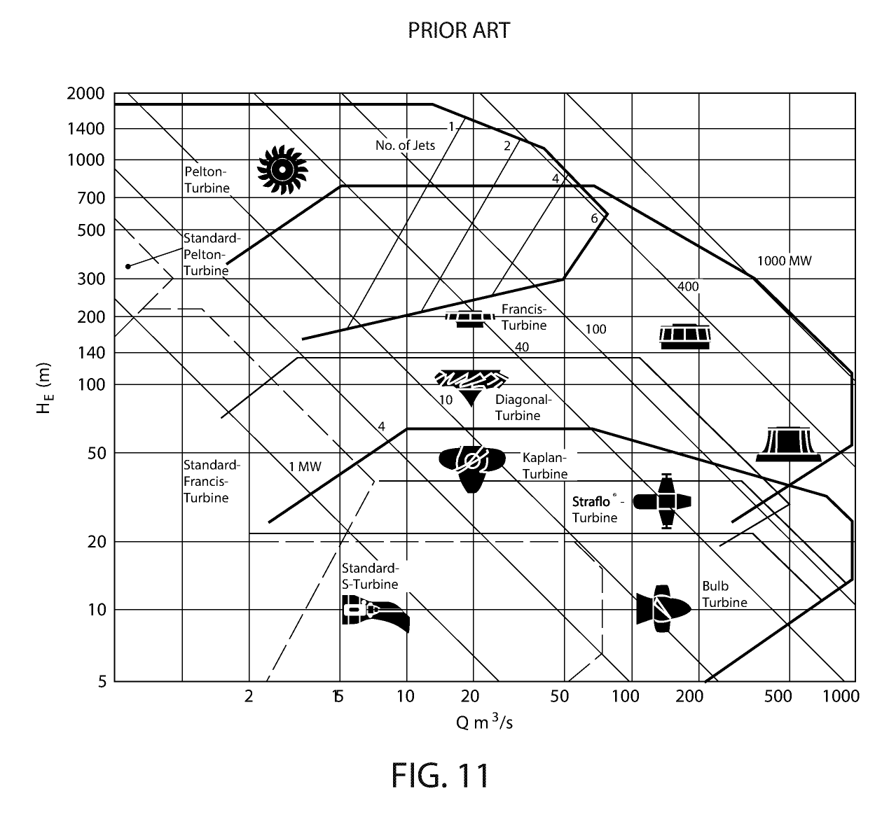

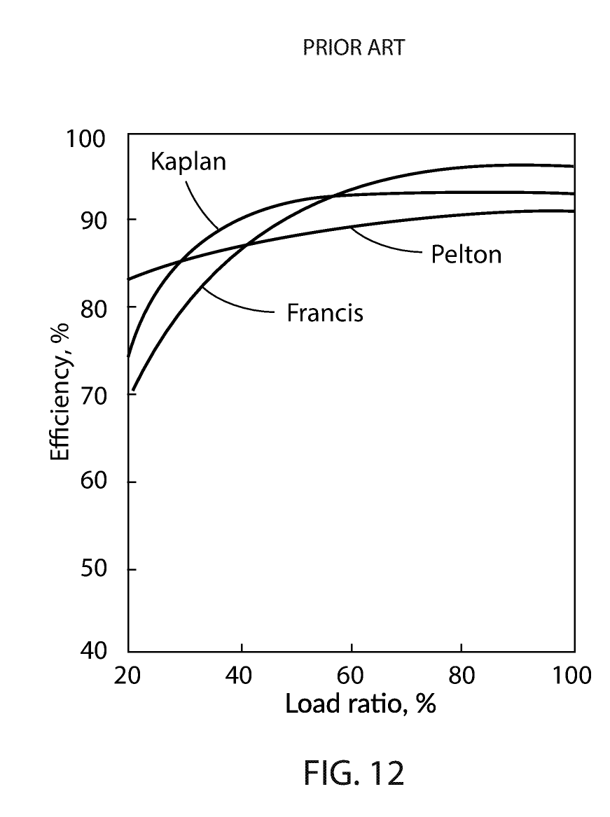

Low tailwater level 20a and high tailwater level 20b are shown in FIGS. 10B and 10C, showing floating powerhouse 1400 lower on the pilings 402 at low tailwater level 20a and higher on pilings 402 at high tailwater level 20b. Floating powerhouse 1400 slides about pilings 402 via bearing guides 1406. Prior systems did not adequately provide for a floating powerhouse such as the one shown, in part because of their large size, and heavy civil works requirements.

At low tailwater level 20a, intake 3204 is completely submerged in upper pool 10.

For example, intake 3204 can be submerged a distance 36a in upper pool 10. At high tailwater level 20b, intake 3204 can be positioned at or above the surface of upper pool 10, resulting in air entering the intake 3204. For example, intake 3204 can be exposed a distance 36b above upper pool 10. In an aspect, turbine 100 does not run when intake 3204 is exposed to air.

In another aspect, at high tailwater level 20b, pressurized water delivery system 3200 can include a bypass gap 34 between a bottom portion of gate 3202 and a lower portion of dam 30 (FIG. 10C). Bypass gap 34 allows excess water to flow under gate 3202.

In another aspect of the invention, the pressurized water delivery source can include one or more right-angle swivel joints to enable the floating powerhouse 1400 to move up and down with a minimum penstock length. In this concept, the head wall is static. This concept is very similar to the flexible penstock, described above, but could be made more compact due to the fact that the swivel joints can rotate completely, instead of using bellows joints which can have a restricted range of motion. In this aspect, the bearing guides for the floating platform include cavities slotted in a direction perpendicular to the general water flow direction.

Turbines as described above may operate in an air-filled vacuum case, in which air bubbles are entrained by the jet and evacuated from the case by momentum of the outgoing fluid. As described, in floating barge applications, the floating platform itself may serve as a draft chamber, with a portion of the floating platform having an opening 404 serving as the opening to the draft chamber. As these bubbles are evacuated, the lower pool is sucked upwards in the draft chamber, recovering useful head below the turbine. This concept allows the turbine and associated equipment to be situated above tailwater, yet not lose the water fall below the turbine as working head. This is useful, for example, to avoid damage from flood waters, accommodate natural variations in tailwater, and to minimize construction cost.

The Summary and Abstract sections may set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention.

Features of each embodiment disclosed may be used in each of the other embodiments disclosed.

Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A turbine system, comprising:
a turbine;
a floating platform supporting the turbine at a tailwater level; and
a pressurized water delivery system coupling a fluid flow source to the turbine, wherein the pressurized water delivery system is configured to permit vertical movement of the floating platform from a first vertical position representative of a first tailwater level to a second vertical position representative of a second tailwater level.

2. The turbine system of claim 1, wherein the pressurized water delivery system comprises:
a first penstock pipe section;
a second penstock pipe section; and
a flexible coupling having a first mating portion connected to the first penstock pipe section and a second mating portion connected to the second penstock mating portion.

3. The turbine system of claim 2, wherein flexible coupling includes a flexible portion configured to allow the first penstock pipe section and the second penstock pipe section to be disposed at a non-zero angle to one another.

4. The turbine system of claim 3, wherein the flexible portion allows between about 1 degree and about 10 degrees of rotational movement between the first penstock pipe section and the second penstock pipe section.

5. The turbine system of claim 1, wherein the floating platform is a modular barge.

6. The turbine system of claim 1, wherein the floating platform includes a draft chamber formed in the floating platform.

7. The turbine of claim 1, wherein the floating platform is substantially constrained along a vertical axis.

8. The turbine of claim 7, wherein in response to a severe flood event, the floating platform is released from the constraint of the vertical axis.

9. The turbine system of claim 1, further comprising a second floating platform supporting the turbine.

10. The turbine system of claim 1, further comprising:
a drive shaft driven by the linear turbine, the drive shaft configured to drive an electric generator positioned exterior to a housing of the linear turbine.

11. The turbine system of claim 9, further comprising:
a third floating platform supporting a second turbine.

12. A turbine system, comprising:
a turbine disposed on a floating powerhouse; and
a flexible penstock to couple the turbine to a fluid intake,
wherein the flexible penstock can rotate about a substantially horizontal axis in response to a vertical position change of the floating powerhouse, such that a fluidic connection between the turbine and a fluid flow source is maintained.

13. The turbine of claim 12, wherein in response to a severe flood event, the floating powerhouse is released from a piling.

14. The turbine system of claim 12, wherein the flexible penstock comprises a flexible coupling that allows between about 1 degree and about 10 degrees of rotational movement between a first penstock segment and a second penstock segment.

15. A floating powerhouse, the floating powerhouse comprising:
a floating platform to support a turbine; and
a pressurized water delivery system coupling a fluid flow source to the turbine,
wherein the pressurized water delivery system is configured to permit vertical movement of the floating platform from a first vertical position representative of a first tailwater level to a second vertical position representative of a second tailwater level.

16. The floating powerhouse of claim 15, wherein the pressurized water delivery system comprises:
a first penstock pipe section;
a second penstock pipe section; and
a flexible coupling having a first mating portion connected to the first penstock pipe section and a second mating portion connected to the second penstock mating portion.

17. The floating powerhouse of claim 16, wherein flexible coupling includes a flexible portion configured to allow the first penstock pipe section and the second penstock pipe section to be disposed at a non-zero angle to one another.

18. The floating powerhouse of claim 17, wherein the flexible portion allows between about 1 degree and about 10 degrees of rotational movement between the first penstock pipe section and the second penstock pipe section.

19. The floating powerhouse of claim 15, wherein the floating platform is substantially constrained along a vertical axis.

20. The floating powerhouse of claim 15, further comprising a second floating platform supporting the turbine.
